(19) United States
(12) Patent Application Publication
(10) Pub. No.: US 2005/0024776 A1
(43) Pub. Date: Feb. 3, 2005

(54) Head suspension assembly, head stack assembly and disk apparatus

(75) Inventor: Kenji Tsuruta, Ome-shi (JP)

Correspondence Address: PILLSBURY WINTHROP, LLP, P.O. BOX 10500, MCLEAN, VA, 22102, US

(73) Assignee: KABUSHIKI KAISHA TOSHIBA, Tokyo (JP)

(21) Appl. No.: 10/901,291

(22) Filed: Jul. 29, 2004

(30) Foreign Application Priority Data
Jul. 31, 2003 (JP) 2003-283554

(51) Int. Cl. G11B 5/48

(52) U.S. Cl. 360/244.1

(57) ABSTRACT

A hard disk drive has a head suspension assembly having a magnetic head at the front end. The head suspension assembly is configured by providing a suspension at the front end of an arm. Near the front end of the arm, a fitting hole is made for containing a pair of Schottky diodes. By providing the Schottky diodes in the part of the arm near the magnetic head, the wiring between the magnetic head and Schottky diodes can be shortened, and the influence of noise can be suppressed.

### CROSS-REFERENCE TO RELATED APPLICATIONS

This application is based upon and claims the benefit of priority from prior Japanese Patent Application No. 2003-283554, filed Jul. 31, 2003, the entire contents of which are incorporated herein by reference.

### BACKGROUND OF THE INVENTION

1. Field of the Invention

The present invention relates to a head suspension assembly having a head at the front end for recording and reproducing information in/from a disk medium, a head stack assembly composed of a plurality of stacked head suspension assemblies, and a disk apparatus having a head stack assembly.

2. Description of the Related Art

As a conventional head suspension assembly having a head at the front end for recording and reproducing information in/from a disk medium, it is known that a recess is made at the middle of a suspension such as a leaf spring provided at the front end of an arm swung by an actuator, and a head IC which drives a head provided at the front end of the suspension is contained in the recess (for example, refer to U.S. Pat. No. 6,437,944, B2).

By providing a head IC in a suspension, the wiring between the head and head IC can be shortened, and the influence of noise on the wiring can be reduced. Further, by making a recess in the suspension and placing a head IC in the recess, the head IC projection height can be made lower than the height of the head IC itself, compared with the case of not providing a recess, sufficient space can be provided between the head IC and magnetic disk located nearby, thus preventing defects caused by contact between the head IC and magnetic disk.

However, it is necessary to bend a suspension to trace a head slider to a medium with a good response to cancel changes in a gap in order to keep a gap constant between the head and medium surface when floating the head slider against the medium. Thus, if the head IC is mounted on the suspension as described above, this causes a problem that the response to trace the head slider to the medium becomes bad. Namely, the suspension is required to have a high response to trace speedily the head to change in a gap, and the mounting of the head IC on the suspension is disadvantageous to improvement of the response. Further, it is thought technically impossible to mount the head IC on the suspension while maintaining a high response.

### BRIEF SUMMARY OF THE INVENTION

It is an object of the present invention to provide a head suspension assembly on which electronic components can be mounted near a head while keeping a high response to changes in a gap in order to keep a gap between the head and medium, a head stack assembly having a plurality of the head suspension assembly, and a disk apparatus having the head stack assembly.

In order to achieve the above object, a head suspension assembly according to an embodiment has a head suspension assembly which has a head at the front end for recording and reproducing information in/from a disk-like medium, and moves the head along the surface of the medium by swinging, comprising: a suspension like a leaf spring having the head at the front end; an arm like a thin plate supporting and fixing the base end of the suspension; and a fitting hole made in the arm for containing an electronic component connected electrically to the head.

According to the above embodiment, electronic components are contained in a fitting hole of an arm which supports and fixes a suspension, and a head can be traced with a high response to changes in a gap between the medium and head provided at the front end of the suspension, compared with the case where electronic components are mounted on a suspension.

A head stack assembly according to an embodiment of the present invention has a head stack assembly having a structure in which two head suspension assemblies according to claim 4 are stacked so that second surfaces of the arm face each other, wherein the electronic component projected from the fitting hole of one head suspension assembly fits into the fitting hole of the other head suspension assembly.

According to the above embodiment, the head stack assembly is constructed to fit the projected portions of the electronic components contained in the fitting hole of each arm of two head suspension assemblies in the other fitting hole, and the dimension of the head stack assembly along the stacking direction can be reduced, and the apparatus structure can be made compact.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the embodiments given below, serve to explain the principles of the invention.

FIG. 1 is a perspective view showing a disassembled hard disk drive according to an embodiment of the present invention;

FIG. 2 is a plane view of a head suspension assembly incorporated in the hard disk drive of FIG. 1, viewed from a magnetic disk;

FIG. 3 is a bottom view of the head suspension assembly of FIG. 2, viewed from the opposite side;

FIG. 4 is a circuit diagram showing the circuit structure of the head suspension assembly of FIG. 2;

FIG. 5 is a partially magnified perspective view showing the part near a fitting hole in the state that two head suspension assemblies are stacked;

FIG. 6 is a sectional view cut along lines VI-VI of FIG. 5; and

FIG. 7 is a sectional view cut along lines VII-VII of FIG. 5.

### DETAILED DESCRIPTION OF THE INVENTION

Hereinafter, detailed explanation will be given on an embodiment of the present invention applied to a hard disk drive 1 (hereinafter referred to as HDD 1) as a disk apparatus with reference to the accompanied drawings.

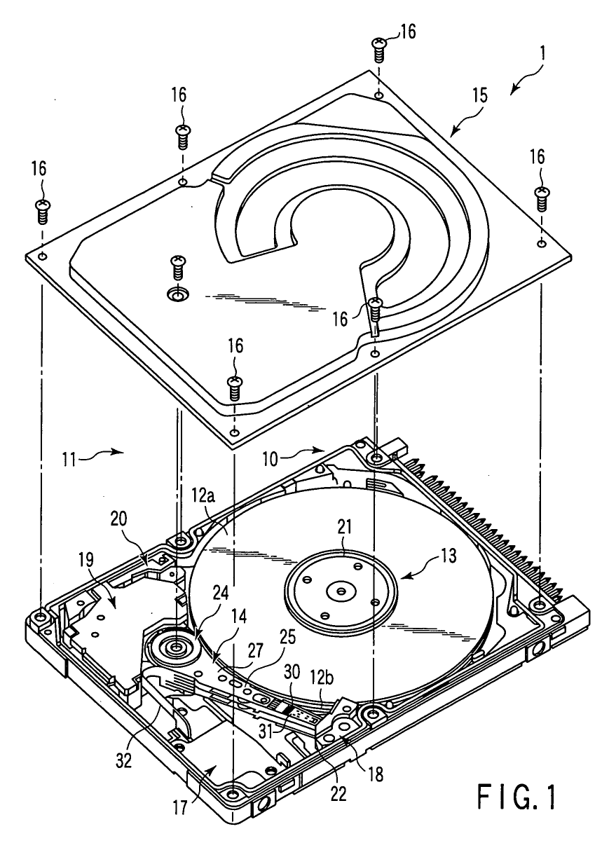

As shown in FIG. 1, a HDD 1 has an airtight flat rectangular case 11. The case 11 has a case body 10 like a rectangular box with the upper side opened, and a top cover 15 like a rectangular plate which is fixed to the case body 10 by a plurality of screws 16 and closes the upper end opening of the case body 10.

Contained in the case body 10 are magnetic disks 12a and 12b as magnetic recording media (disk-like media) (hereinafter, generically referred to as a magnetic disk 12), a spindle motor 13 (a first motor) which supports and rotates these magnetic disks 12, a plurality of magnetic heads 22 (head) which record/reproduce information in/from the magnetic disks 12, a head stack assembly 14 which movably supports the magnetic heads 22 over the magnetic disks 12a and 12b, a voice coil motor 19 (a second motor) (hereinafter, referred to as a VCM 19) which rotates and positions the head stack assembly 14, a ramp load mechanism 18 which keeps the magnetic head 22 at a retreated position away from magnetic disk 12 when the magnetic head 22 moves to the outermost periphery of the magnetic disk 12, and controls the swing of the outer periphery of the magnetic disk 12 in the surface direction, an inertia latch mechanism 20 which keeps the head stack assembly 14 in the retreated position, and a flexible printed circuit board unit 17 (hereinafter, referred to as a FPC unit 17) on which a preamplifier and other circuit components are mounted.

On the outside surface of the case body 10, a printed circuit board (not shown) to control operation of the spindle motor 13, VCM 19 and the magnetic head 22 through the FPC unit 17 is fixed by screws, and the printed circuit board is placed opposing the bottom wall of the case.

Each of the magnetic disks 12a and 12b has a magnetic recording layer on the upper and lower surfaces. The two magnetic disks 12a and 12b are fit coaxially to each other in a not-shown hub of the spindle motor 13, clamped by a clamp spring 21, and stacked with a fixed space along the axial direction of the hub. The magnetic disks 12a and 12b are rotated by the spindle motor 13 at a fixed speed.

The head stack assembly 14 has a bearing assembly 24 fixed to the bottom wall of the case 10, and four head suspension assemblies 25 fixed to the bearing assembly 24. Each head suspension assembly 25 has an arm 27 fixed to the bearing assembly 24, and a magnetic head assemblies 30 supported by and fixed to the front end of the arm 27. Each magnetic head assembly 30 has a slender suspension 31 composed of a leaf spring, and magnetic heads 22 fixed to the front end of the suspension 31.

Each magnetic head 22 is electrically connected to the FPC unit 17 through a relay flexible printed circuit board 33 (a wiring board-hereinafter, simply called a board 33) explained later which is fixed to the arm 27 and the surface of the suspension 31, and a main flexible circuit board 32.

When the HDD 1 is operated, the head stack assembly 14 is rotated by the VCM 19, and the four magnetic heads 22 are moved in the substantially radial direction along the surface of the magnetic disks 12a and 12b, and positioned on a desired track.

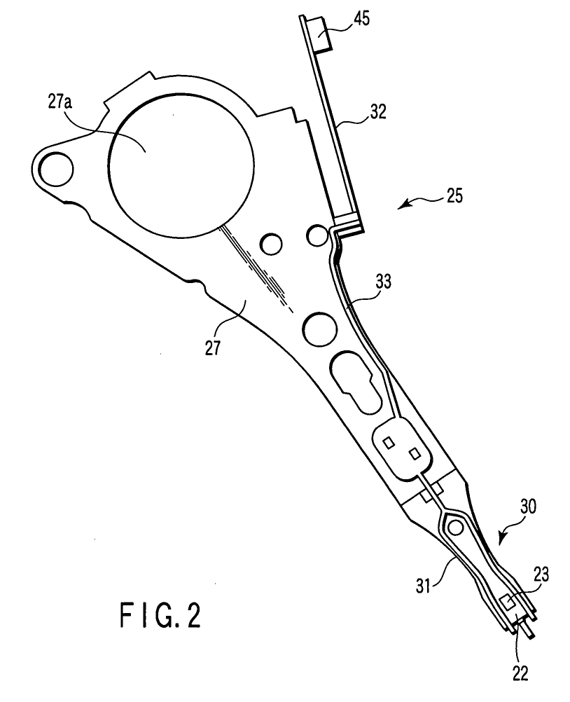

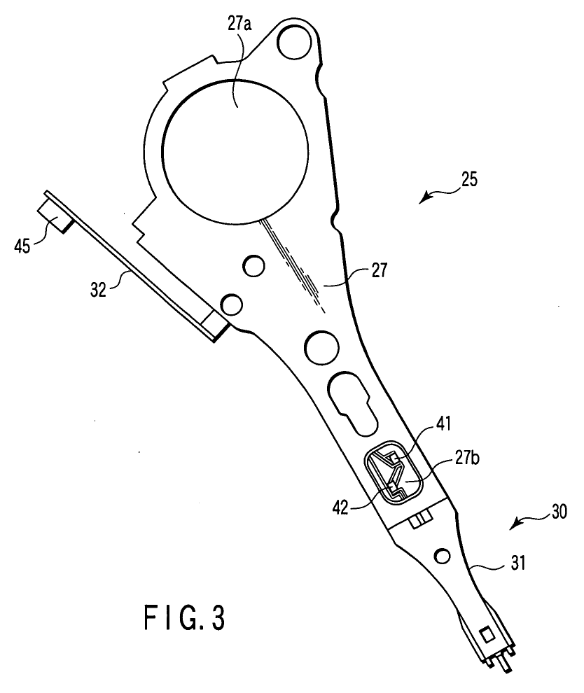

Next, the above-mentioned head suspension assembly 25 will be explained in detail by referring to FIG. 2 and FIG. 3. FIG. 2 is a plane view of the head suspension assembly 25, viewed from the corresponding magnetic disk 12. FIG. 3 is a bottom view of the head suspension assembly 25, viewed from the opposite side.

The head suspension assembly 25 (hereinafter, referred to as a HSA 25) has an arm 27 like a thin plate and a suspension 31, as explained above. The arm 27 is made of a metallic plate with a thickness of 0.25 mm, and has a circular hole 27a to be fixed to the bearing assembly 24 near the base end. The base end of the leaf spring suspension 31 is partially stacked and fixed to the front end of the arm 27 remote from the bearing assembly 24, so that the suspension 31 is supported by the arm 27. More specifically, the suspension 31 is stacked to the upper surface (a first surface) of the arm 27 that faces the magnetic disk 12.

At the front end of the suspension 31 remote from the arm 27, a head slider 23 like a rectangular block formed with the head 22 is provided. The head slider 23 is fixed to the upper surface side opposite to the magnetic disk 12 through gimbals like a leaf spring provided at the front end of the suspension 31.

Near the front end of the arm 27 provided with the suspension 31, a fitting hole 27b is provided penetrating the arm 27 to receive a pair of Schottky diodes 41 and 42 (electronic components). By providing the fitting hole 27b in the part of the arm 27 near the magnetic head 22 like this, the wiring for connecting the magnetic head 22 to the Schottky diodes 41 and 42 can be shortened as much as possible, thus the influence of noise on the wiring can be suppressed.

To shorten the wiring, it is also considered to provide the Schottky diodes 41 and 42 in the suspension 31. But, if electronic components are provided in the suspension 31, the traceability of the head slider 23 to the magnetic disk becomes bad. Namely, to keep the gap between the head slider 23 and magnetic disk 12 in the order of several tens of microns in the stated that the head slider 23 is floated from the surface of the magnetic disk 12, the suspension traces the head slider 23 to the magnetic disk surface by changing the form to cancel changes in the gap.

Therefore, in this embodiment, by providing the Schottky diodes 41 and 42 in the arm 27, the noise in the wiring can be effectively suppressed without deteriorating the traceability of the head slider 23 to the magnetic disk 12.

Further, it is technically difficult to mount electronic components like Schottky diodes 41 and 42 on the suspension 31 having the characteristic of a spring. Contrarily, as in this embodiment, electronic components can be easily mounted by providing the Schottky diodes 41 and 42 in the arm 27.

A pair of Schottky diodes 41 and 42 contained in the fitting hole 27b are mounted on the board 33 fixed to the upper surface of the arm 27. More specifically, the board 33 is provided just like closing one end of the fitting hole 27b on the side of the magnetic disk 12, and a pair of Schottky diodes 41 and 42 is mounted in the non-contacted state on a part of the board 33 exposed in the fitting hole 27b.

In this embodiment, the thickness of the arm 27 is 0.25 mm, and the mounting height of the Schottky diodes 41 and 42 is 0.4 mm. Thus, the Schottky diodes 41 and 42 project from the fitting hole 27b to the opposite surface (a second surface) of the arm 27.

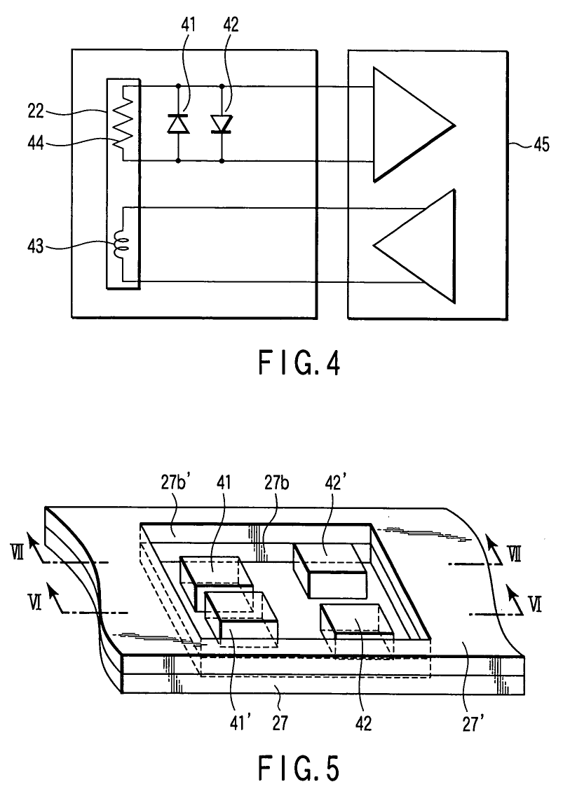

FIG. 4 shows the circuit diagram of the electronic components provided on the circuit boards 32 and 33 of the above-mentioned HSA 25.

According to the drawing, the magnetic head 22 has a thin film coil 43 for writing, and a MR element 44 for reading. The above-mentioned pair of Schottky diodes 41 and 42 are connected between the terminals of the MR element 44. Connected to the magnetic head 22 is a head amplifier circuit 45, which amplifies/outputs a playback signal entered through the MR element 44, and outputs a recording signal to write in the magnetic disk 12 through the thin film coil 43. The pair of Schottky diodes 41 and 42 protect the magnetic head 22 from a breakdown by preventing a large current flow through the MR element 44. The head amplifier circuit 45 is mounted on the main flexible circuit board 32 separated from the magnetic head 22, as shown in FIG. 2.

The HSA 25 configured as above is stacked by four and mounted on the bearing assembly 24, forming the head stack assembly 14, and incorporated in the HDD 1 so that each head slider 23 opposes each surface of the magnetic disks 12a and 12b. Therefore, two HSA 25s placed between two magnetic disks 12a and 12b are mounted in the state that the bottoms surfaces (opposite surfaces) are stacked.

Hereinafter, explanation will be given on the HSA 25 and 25′ stacked and placed between the two magnetic disks 12a and 12b with reference to FIG. 5 to FIG. 7. A dash (′) is given to the reference numerals in order to show that HSA 25 and 25′ have the same structure.

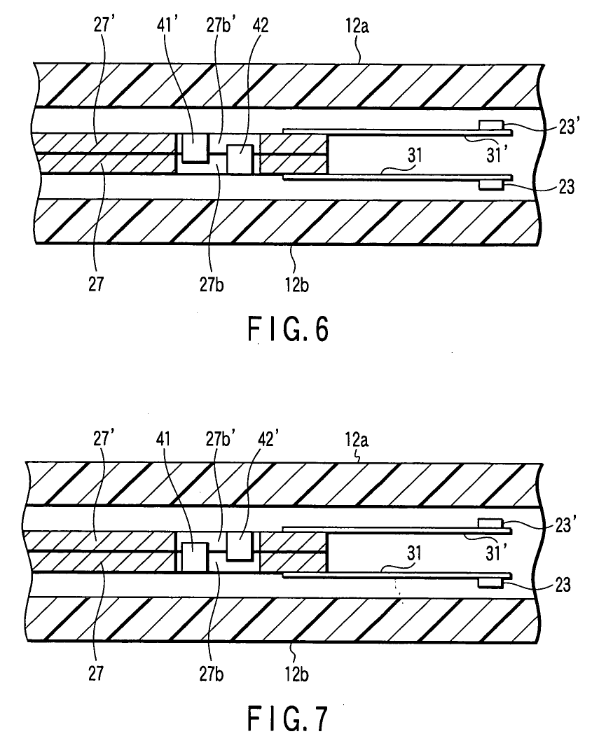

FIG. 5 is a partially magnified perspective view showing the part near the fitting holes 27b and 27b′ of the Schottky diodes with the two HSA 25 and 25′ stacked. FIG. 6 is a sectional view cut along line VI-VI of FIG. 5. FIG. 7 is a sectional view cut along line VII-VII of FIG. 5. The circuit boards 33 and 33′ of the HSA 25 and 25′ are not shown to simplify the figure.

The HSA 25 and 25′ are fixed to each other in the state that the bottom surfaces with the Schottky diodes 41, 42 and 41′, 42′ projected are faced to each other. As the Schottky diodes 41, 32 and 41′, 42′ are projected from the fitting holes 27b and 27b′, this becomes obstructive when sticking the bottoms of the two HSA 25 and 25′.

Thus, in this embodiment, the Schottky diodes are positioned, so that the Schottky diodes 41, 42 and 41′, 42′ of HSA 25 and 25′ are placed in a zigzag configuration and not contacted each other in the combined two fitting holes 27b and 27b′. In this embodiment, the mounting height of the Schottky diodes 41 and 42 is 0.4 mm, and less than the thickness of the stacked two arms 27 and 27′ (0.25 mm×2=0.5 mm). Thus, the thickness of the stacked two HSA 25 and 25′ is equal to the thickness of the stuck arms 27 and 27′.

As explained above, according to this embodiment, since the Schottky diodes 41 and 42 are contained in the fitting hole 27b made in the arm 27 of HSA 25, and the Schottky diodes 41 and 42 can be approximate to the magnetic head 22 without deteriorating the traceability of the head slider 23 to the magnetic disk 12. Thus, the wiring for connecting the Schottky diodes 41 and 42 to the magnetic head 22 can be shortened, and the influence of noise on the wiring can be suppressed.

Further, since the Schottky diodes 41 and 42 are provided in the fitting hole 27b of the arm 27, the Schottky diodes 41 and 42 can be easily mounted, compared with the case where the Schottky diodes 41 and 42 are provided in the suspension 31.

Further, by containing the Schottky diodes 41 and 42 in the fitting hole 27b of the arm 27, it is possible to mount the Schottky diodes 41 and 42 having a mounting height greater than the thickness of the arm 27. In this case, the mounting height is restricted to a value not exceeding double the thickness of the arm 27.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

For example, in the above-mentioned embodiment, a pair of Schottky diodes 41 and 42 are contained and placed in the fitting hole 27b of the arm 27, but the electronic components are not limited to Schottky diodes. Other electronic components such as a head amplifier circuit 45 can also be contained in the fitting hole 27b. In this case, the size and shape of the fitting hole 27b may be changed to meet the type, size, quantity, and other conditions of an electronic component to be provided. It is also possible to change the positional relationship and quantity of the electronic components to be contained in the fitting hole 27b. Regardless, all electronic components are to be placed without being stacked.

Further, in the above-mentioned embodiment, the present invention is applied to the HDD 1 having two magnetic disks 12a and 12b, but the application of the invention is not limited to this. The invention is applicable also to an apparatus having three or more magnetic disks. In this case, the number of HSA 25 and 25′ placed in being stacked between two magnetic disks is increased, the size of the apparatus can be reduced furthermore along the HSA stacking direction.

1. A head suspension assembly which has a head at the front end for recording and reproducing information in/from a disk-like medium, and moves the head along the surface of the medium by swinging, comprising:
a suspension like a leaf spring having the head at the front end;
an arm like a thin plate supporting and fixing the base end of the suspension; and
a fitting hole made in the arm for containing an electronic component connected electrically to the head.

2. The head suspension assembly according to claim 1, wherein the fitting hole penetrates the arm.

3. The head suspension assembly according to claim 2, further comprising a wiring board having a wire to connect electrically the head to the electronic component,
wherein the wiring board is provided on a first surface of the arm opposite to the medium just like closing the fitting hole, and
the electronic component placed in the fitting hole is mounted on the wiring board.

4. The head suspension assembly according to claim 3, wherein the electronic component has the mounting height exceeding the thickness of the arm, and projects to a second surface remote from the first surface.

5. The head suspension assembly according to claims 1-4, wherein a plurality of electronic components are placed in the fitting hole.

6. The head suspension assembly according to claims 1-4, wherein the electronic components include at least one of a Schottky diode and a head amplifier circuit.

7. A head stack assembly having a structure in which two head suspension assemblies according to claim 4 are stacked so that second surfaces of the arm face each other,
wherein the electronic component projected from the fitting hole of one head suspension assembly fits into the fitting hole of the other head suspension assembly.

8. The head stack assembly according to claim 7, wherein the mounting height of the electronic component is less than double the thickness of the arm.

9. The head stack assembly according to claim 8, wherein a plurality of electronic components are provided in each head suspension assembly, and placed in two fitting holes without contacting each other.

10. The head stack assembly according to claim 8, wherein the electronic components include four Schottky diodes provided two each in each head suspension assembly, the four Schottky diodes are arranged in a zigzag configuration within the opposite two fitting holes.

11. A disk apparatus comprising:
a head suspension assembly according to one of claims 1-6;
a first motor which supports and rotates the disk-like medium; and
a second motor which swings the head suspension assembly.

12. A disk apparatus comprising:
a head stack assembly according to one of claims 7-10;
a first motor which supports and rotates said two disk-like media opposite to the first surface of the head suspension assembly in the coaxial and separated state; and
a second motor which swings the head stack assembly.
